(19) United States
(12) Patent Application Publication
(10) Pub. No.: US 2002/0010772 A1
(43) Pub. Date: Jan. 24, 2002

(54) System and method for communication based on priority class selection

(75) Inventor: Toshihiko Kusano, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/906,856

(22) Filed: Jul. 18, 2001

(30) Foreign Application Priority Data
Jul. 19, 2000 (JP) 2000-219609

(51) Int. Cl. G06F 15/173

(52) U.S. Cl. 709/223; 709/240

(57) ABSTRACT

An object of the present invention is to provide a priority class selection type communication system and method wherein users can ensure transmission channel, select priority class, change priority freely according to their conditions, thereby optimizing communication cost. An user terminal comprises a connection opening trigger detecting unit for detecting start of transmission and reception, an information requesting unit for requesting network information of each priority class, a priority class selecting unit for selecting a priority class, a utilization requesting unit for requesting to utilize the selected priority class and a transceiver for transmits and receives information by permission ID. A network control unit comprises a network information transferring unit which transmits network information, a network database which stores network information and a request accepting unit which transmits permission ID.

### BACKGROUND OF THE INVENTION

1. Technical Field of the Invention

The present invention relates to a communication system and method, wherein a priority class is selected for optimizing communication cost.

2. Description of the Prior Art

Conventionally, priority in communication is associated with kinds of communication services. For example, in the ATM (Asynchronous Transfer Mode), wherein information including sound, data, video and the like is loaded on a cell of fixed bytes, there are several network service classes such as CBR (Constant Bit Rate; service for image communication), VBR (Variable Bit Rate; service for realizing communication at information variable speed as it is), UBR (Unspecified Bit Rate; service, for low cost, not guaranteeing throughput) and the like. However, a user terminal has generally only one specific transmission protocol. Therefore, the users must always use a priority class of the same communication protocol.

A bandwidth allocating system in a packet communication network disclosed in JP 3-58646 A (1991) uses two priorities, thereby guaranteeing communication quality. Concretely, a bandwidth allocation for the first priority is conducted for a transmission channel passing under a bandwidth which is equal to maximum value of packet sending speed of information source, while a bandwidth allocation for the second priority conducted for a transmission channel passing under a virtual bandwidth which is not smaller than an average of packet sending speed of information source and is not greater than the maximum of that. Further, a packet having first priority is transmitted preferentially than a packet having second priority in network.

As described above, the priorities are classified mainly on the basis of transmission protocol such as CBR, VBR and UBR, for example. Therefore, in the case of ATM transmission, the terminal has generally only specific transmission system. Thus, the conventional priority system has a disadvantage that the users must always use priority class of the same communication system.

Accordingly, for example, when the user wants to transfer electronic file on business urgently, and when the user browses home pages through Internet, the user utilizes the network in the same priority class, so to say. According to the provision of UNI (User Network Interface), it is possible for a user to request a bandwidth, by means of exchanging parameter between the user terminal side and the network side.

However, such a system requires complicated protocol between the network side and the user side, and the users do not know easily what and why they demand the network to do. Therefore, it is difficult to provide suitable service for flexible request of the users.

### SUMMARY OF THE INVENTION

Accordingly, it is an object of the present invention to provide a priority class selection type communication system and method which can ensure transmission channel by using classification of priority independent of communication protocol, thereby setting up communication cost corresponding to the priorities, selecting a priority class according to policy whenever transmitting, changing the priority freely in accordance with conditions on the basis of the importance of information and the like. It is another object of the present invention to do away with contracts in which the user always uses specific priority class and to optimize communication cost.

The present invention is characterized in that in a priority class selection type communication system for conducting use of network corresponding to priority, a specific band of a transmission channel in the network is classified and divided by priority; maximum user number is set by each priority class; and then lower limit of usable band is set as guarantee value at the time of use by maximum number of user based on the band of the each priority class and the maximum user number.

And, the present invention is characterized in that in a priority class selection type communication method in a priority class selection type communication system comprising a user terminal and a network control unit, request of network information of the priority class divided corresponding to a specific band of a transmission channel in the network and maximum user number is conducted from the user terminal to the network control unit at a stating time of transmission and reception of information between a user terminal and another user terminal, and it is determined that the terminal selects which priority class based on the network information that the user terminal received from the network control unit based on the request; that use request of determined priority class is conducted from the user terminal to the network control unit, and communication is conducted with permission ID that the user terminal received from the network control unit based on the request.

In addition, in a priority class selection type communication system of the present invention, describing while referring to FIG. 1, the user terminal (1) comprises detecting means (11) which detect start of transmission and reception of information between itself and another user terminal; first requesting means (12) which conduct request of network information of the each priority class to the network control unit (2); determining means (13) which determine that the means select which priority class based on the network information received from the network control unit (2) based on the request and selection policy that user has; second requesting means (15) which conduct use request of determined priority class to the network control unit (2); and transmitting and receiving means (16) which conduct transmission and reception of information through the network (3) with the permission ID received from the network control unit (2) based on the request, and the network control unit (2) comprises transferring means (21) which receive request of the network information from the user terminal (1) and transmit the network information to the user terminal (1), storing means (22) which can store and update the network information and accepting means (23) which receive the use request from the user terminal (1) and transmit the permission ID to the user terminal when the network (3) is usable.

The priority class selection type communication system of the present invention can ensure transmission channel needed for transfer for itself by payment of proper compensation of each user and select priority class to be used according to the policy at the time of transmitting. Therefore, priority may be changed randomly according to conditions to be used based on the importance of information and the like, no contract in which user always uses specific priority class is needed, and optimization of communication cost may be realized.

According to the present invention, effect described below is obtained because of the following reason, that is, since request of network information of each priority class divided corresponding to the specific bandwidth of the transmission channel in the network and maximum user number is conducted from the user terminal to the network control unit with start of transmission and reception of information between the user terminal and another user terminal, it is determined that the terminal selects which priority class based on network information that the user terminal received from the network control unit based on request, use request of determined priority class is conducted from the user terminal to the network control unit, and communication is conducted with permission ID that the user terminal received from the network control unit based on request, in addition, each priority class has specific account system and unit price per unit bandwidth is set high as priority class limiting containing user number.

It is possible to ensure transmission channel needed for transfer for itself by payment of compensation of each user and select priority class to be used, therefore, priority may be changed randomly according to conditions to be used based on the importance of information and the like, no contract in which user always uses specific priority class is needed, and optimization of communication cost may be realized.

### BRIEF EXPLANATION OF THE DRAWINGS

FIG. 1 is a block diagram showing an example of constitution of the priority class selection type communication system of the embodiment of the present invention.

FIG. 2 shows one example of network information that the network control unit of the priority class selection type communication system of the embodiment of the present invention provides to the user terminal.

FIG. 3 shows one example of network information that the network control unit of the priority class selection type communication system of the embodiment of the present invention provides to the user terminal.

FIG. 4 shows one example of database information that the network control unit of the priority class selection type communication system of the embodiment of the present invention has.

FIG. 5 shows one example of database information that the network control unit of the priority class selection type communication system of the embodiment of the present invention has.

FIG. 6 is a flow chart showing a process of the side of the user terminal and that of the network control unit of the priority class selection type communication system of the embodiment of the present invention.

FIG. 7 is a block diagram showing an example of constitution of the priority class selection type communication system of the embodiment of the present invention.

### PREFERRED EMBODDDIMENT OF THE INVENTION

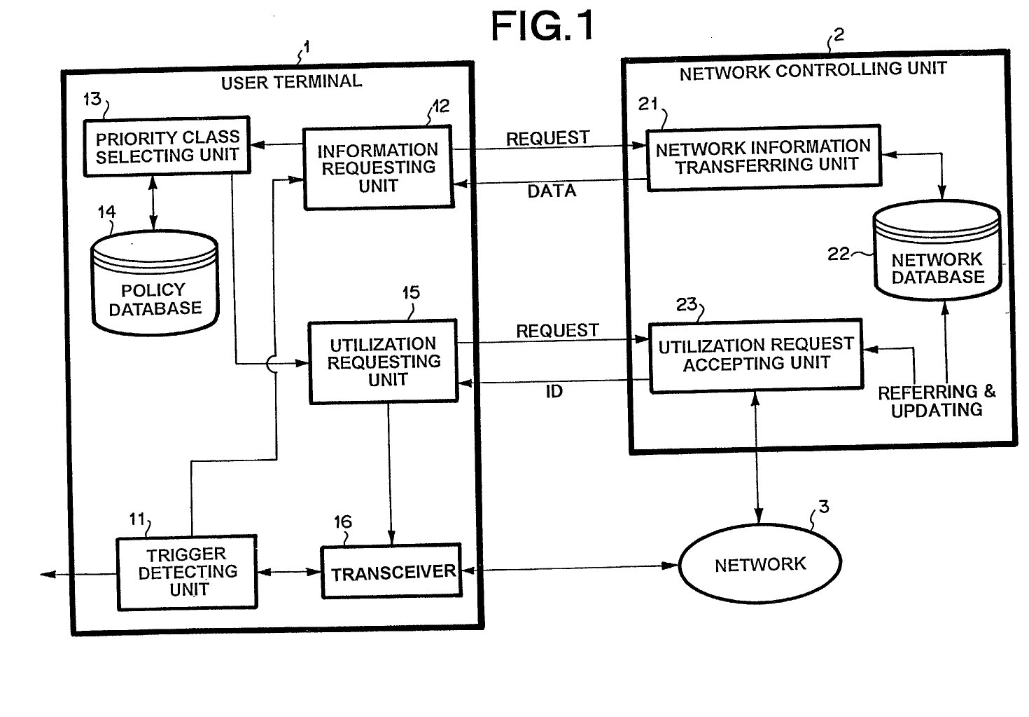

The priority class selection type communication system of an embodiment of the present invention, as shown in FIG. 1 comprises: an user terminal 1 comprising a connection opening trigger detecting unit 11, an information requesting unit 12, a priority class selecting unit 13, a policy database 14, a utilization requesting unit 15 and a transmitting and receiving unit 16; a network control unit 2 comprising a network information transferring unit 21, a network database 22 and a request accepting unit 23; and a transmission channel (network) 3.

Describing above-mentioned constitution in detail, in the user terminal 1, the connection opening trigger detecting unit 11 generates trigger signal for data sending when data to be sent is generated within the user terminal of own office and detects that generated signal become trigger of start of transmission and reception. The information requesting unit 12 inputs trigger signal and requests provision of use information of each priority class to network 3 and transfers received information to the priority class selecting unit 13. The priority class selecting unit 13 determines that it selects which priority according to use conditions of network transferred from the information requesting unit 12 and the policy database (selection policy) 14 that user has.

The utilization requesting unit 15 inputs the selection result of the priority class selecting unit 13 and transmits request of priority class to the network control unit 2 and, as this response, receives usable Id value (referring to Id value hereafter) to transfer information in network from the network control unit 2. The transmitting and receiving unit 16 conducts transmission and reception of information to network 3 with Id that the utilization requesting unit 15 received.

On the other hand, in the network control unit 2, the network information transferring unit 21 receives reference request of network information from the user terminal 1 and transmits network information to the user terminal 1. The network database 22 stores use information. The request accepting unit 23 receives use request from the user terminal 1 and judge whether network 3 is usable and delivers permission ID to the user terminal 1 while updating the network database 22 when acceptance is conducted.

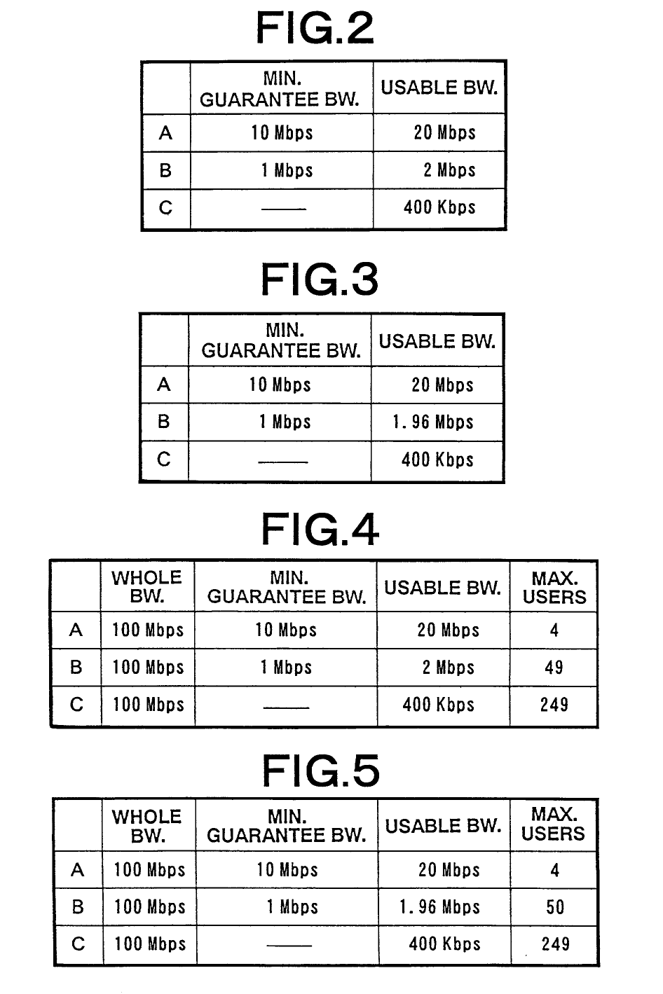

And one example of network information that the network control unit 2 provides to the user terminal 1 is shown in FIG. 2 and FIG. 3, for example, each of priority A class, priority B class and priority C class which are divided into three ranks correspond to minimum guarantee bandwidth and usable bandwidth.

Furthermore, one example of database information that the network control unit 2 has is shown in FIG. 4 and FIG. 5, for example, each of priority A class, priority B class and priority C class which are divided into three ranks correspond to all bandwidth, minimum guarantee bandwidth, usable bandwidth and maximum user number. In this case, FIG. 5 shows updated database information in FIG. 4.

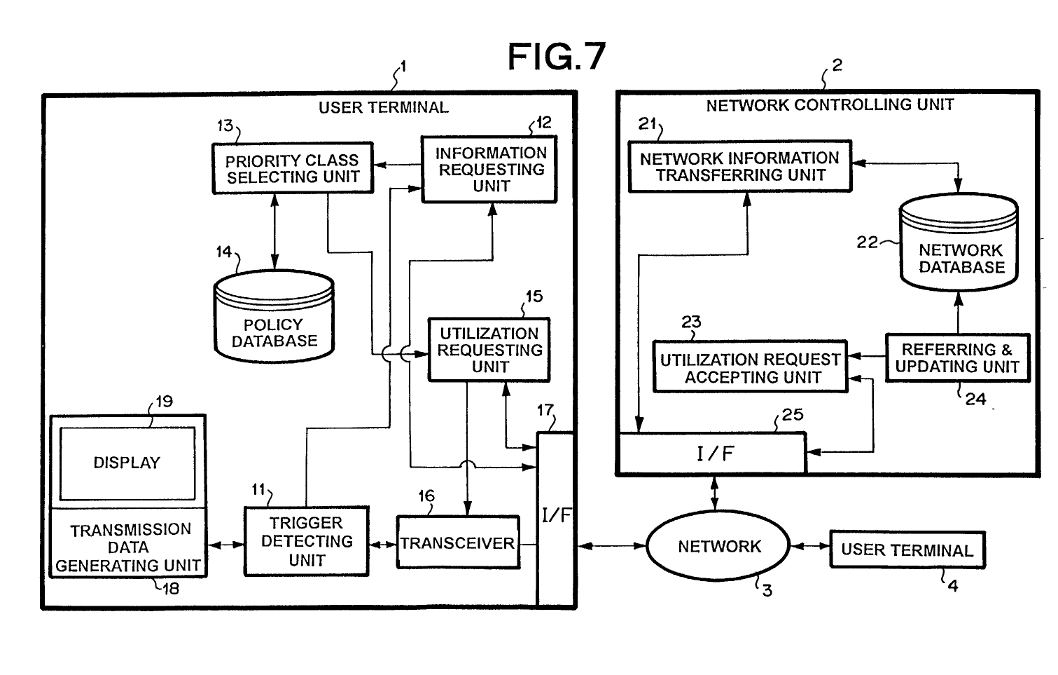

In addition, above-mentioned constitution presents an example that the user terminal 1 and the network control unit 2 are provided with transmission line apart from network 3, however, the user terminal may conduct selection of priority and the like through network similar to another embodiment as shown in FIG. 7 described later with respect to use of network depending on generation of data.

The operation of the embodiment of the present invention is explained in detail with reference to FIG. 1-FIG. 6.

In the user terminal 1, when condition that information is transmitted and received with another terminal is occurred, the connection opening trigger detecting unit 11 detects this occurrence. With respect to methods for detecting connection opening trigger, various detecting methods such as carrier sensing, detection based on occurrence of transmission request in protocol level and detection based on occurrence of transaction request in application level and the like can be considered.

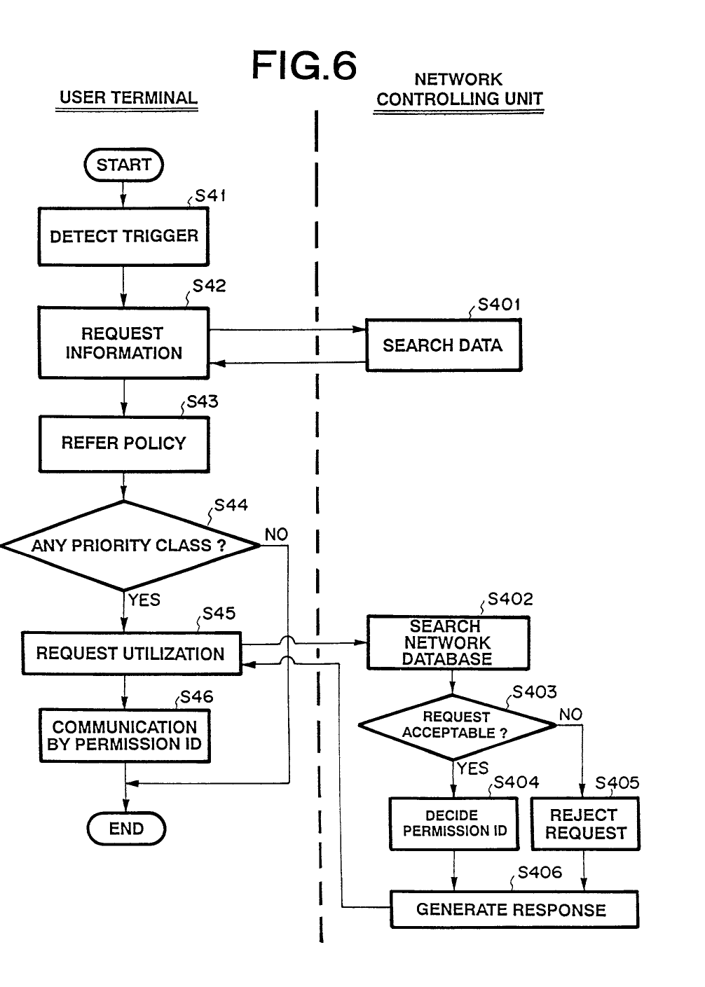

The connection opening trigger detecting unit 11 informs information that the unit 11 detected this connection opening trigger to the information requesting unit 12 (Step 41 in FIG. 6). Additional information to judge quality of information to be transmitted such as transmission application, amount of transfer information and the like is added to this trigger detection information.

The information requesting unit 12 of the user terminal 1 requests notice of use condition of each priority class in network 3 for the network information transferring unit 21 with which the network control unit 2 is provided (Step 42 in FIG. 6). The network information transferring unit 21 refers to the network database 22 according to foregoing request and transfers this information to the information requesting unit 12, which is a request resource, of the user terminal 1 (Step 401 in FIG. 6).

Here, FIG. 2 shows network information which is given at this time. In this embodiment, priority of network is divided into three ranks, these ranks are, in order of raising priority, priority A class, priority B class, and priority C class. Each class has a whole bandwidth of 100 Mbps temporarily, priority A class contains maximum 10 user, priority B class contains maximum 100 user, priority C class contains unlimited user. Priority A class guarantee minimum 10 Mbps, priority B class guarantee minimum 1 Mbps, priority C class guarantee nothing.

Accordingly, network information shown in FIG. 2 shows each minimum guarantee bandwidth and usable bandwidth for each user in each priority class at present. Usable bandwidth show usable bandwidth at the time of addition of new user so that it is easy for user who selects class. Specifically, 2 Mbps of priority B class is calculated by the formula;

2=100/(49+1) (A)

Here, “1” in the formula (A) is added in order to calculate value when this user is added temporarily.

The information requesting unit 12, which received foregoing network information, of the user terminal 1 transfers network information to the priority class selecting unit 13. The priority class selecting unit 13 selects that which priority class is used for information transfer with reference to the policy database 14.

The policy database 14 sets, for example, time emergency, lower limit and upper limit of network use for information and the like by amount of transfer information, a kind of sending application and the like to maintain policy for selecting suitable priority class. The priority class selecting unit 13 determines that which priority class is used with respect to transmission and reception based on this policy (Step 43 and 44 in FIG. 6).

Next, the priority class selecting unit 13 informs the utilization requesting unit 15 of selected priority class (Step 45 in FIG. 6). The utilization requesting unit 15 of the user terminal 1 transmits use request to the request accepting unit 23 of the network control unit 2. In this embodiment, it is assumed that request that priority B class is used is conducted based on the policy database 14.

At this time, information concerning opposed station of communication is delivered. The utilization requesting unit 15 of the user terminal 1 transfers this information, that is, information that priority B class is used to the request accepting unit 23 of the network control unit 2. The request accepting unit 23 obtains information shown in FIG. 4 with reference to the network database 22 (Step 402 in FIG. 6).

Information of FIG. 4 show that all bandwidth and information of user number are added to information of FIG. 2. Priority B class does not reach maximum user number, it is still possible for service for 40 user, therefore, at this time, request is accepted as it is, and the network database 22 is updated (Step 403, 404 in FIG. 6). When acceptance is impossible, acceptance impossible is judged (Step 405 in FIG. 6). FIG. 5 shows updated database. After this, user who conducted request of information transfer receives information shown in FIG. 3.

The request accepting unit 23 of the network control unit 2 assigns ID so that user can use priority B class in network 3 (Step 406 in FIG. 6) and informs this to the utilization requesting unit 15 of the user terminal 1. The request accepting unit 23 of the network control unit 2 assigns same ID and informs it to the utilization requesting unit 15 of the user terminal 1 in the opposed station simultaneously. And the request accepting unit 23 of the network control unit 2 conducts operation for opening connection of accepted service for network 3.

The utilization requesting unit 15 of the user terminal 1 receives each signal transmitted from the side of the network control unit 2 (Step 45 in FIG. 6), delivers this ID to the transmitting and receiving unit 16 and executes transmission and reception of data between itself and opposed terminal with received ID (Step 46 in FIG. 6).

In addition, in the embodiment described above, an example of the system that user directly specifies priority class in same priority class, however, the system that user only specifies minimum guarantee bandwidth, and the request accepting unit 23 of the network control unit 2 refers to the network database 22 to select suitable class may be applicable.

As described above, in the priority class selection type communication method of the embodiment of the present invention, the specific bandwidth of the transmission channel in the network is classified and divided by priority, and maximum user number is set. And lower limit of usable bandwidth is set as guarantee value when maximum number of user uses by fair share based on bandwidth of each priority class and maximum user number. In addition, priority class, having no guarantee substantially, in which maximum user number is infinity may be set.

Each priority class has specific account system, and unit price per unit bandwidth is set high as priority class limiting containing user number. Network updates at real time and controls minimum guarantee value of its priority class and usable bandwidth information based on use conditions of each priority class.

Network user can obtain use information of each priority class from network by request of user. It is possible to request and reserve that which priority class is used at how much bandwidth for network by user's policy. User is accounted use charge by the product of used priority class, bandwidth and time. Network contains to maximum user number that each priority class has.

Accordingly, the used bandwidth may gradually decrease due to the increase in users, even when users are using bandwidth which exceed minimum guarantee bandwidth.

FIG. 7 is a block diagram of another embodiment of the present invention. As shown in FIG. 7, the difference between FIG. 7 and FIG. 1 is that an user terminal 1 and a network control unit 2 are conducted intercommunication through network 3. Therefore, the user terminal 1 has a terminal interface 17 having a function of mutual mediation between a transmitting and receiving unit 16 and network 3 and is connected with network 3 according to protocol specified by network.

This protocol may be a physical layer, a data link layer, network layer, a transport layer and the like in OSI reference model. The network control unit 2 is provided with a managing unit interface 25 for connection with network 3, and this managing unit interface 25 intervenes between a network information transferring unit 21 and a request accepting unit 23 and between the unit 2 and the user terminal 1 for intercommunication of data.

The user terminal 1 is provided with a display 19 and a transmitting data generating unit 18 having a function of input and output, the transmitting data generating unit 18 generates trigger signal of data output. A connection opening trigger detecting unit 11, an information requesting unit 12, a priority class selecting unit 13, a policy database 14, a utilization requesting unit 15 and a transmitting and receiving unit 16 have the same function as FIG. 1 respectively. When the user terminal 1 receives data from network 3, reception processing is conducted through the terminal interface 17, the transmitting and receiving unit 16 and the connection opening trigger detecting unit 11 while visibly recognizing the display 19 at the transmitting data generating unit 18.

The network control unit 2 is provided with a network information transferring unit 21, a network database 22, a request accepting unit 23, the managing unit interface 25 and a referring and updating unit 24 which conducts reference and update of data of the network database 22. In addition, the network information transferring unit 21 and the request accepting unit 23 may be included in the managing unit interface 25.

Generally, a plurality of user terminals are connected with the transmission channel (network) 3, and the action of an user terminal 4 is the same as the action of the user terminal 1. Since the action of the user terminal 1 and the network control unit 2 are nearly the same as the action described by the embodiment as shown in FIG. 1, overlapping description will be omitted.

Describing above-mentioned constitution in detail, in the user terminal 1, the connection opening trigger detecting unit 11 generates trigger signal for data sending when data to be sent is generated by the transmitting data generating unit 18 within the user terminal of own office and detects that generated signal become trigger of start of transmission and reception. The information requesting unit 12 inputs trigger signal and requests provision of use information of each priority class to the network control unit 2 through the terminal interface 17 for network 3.

At this time, in the case of communication to the network control unit 2, the terminal interface 17 accepts its request while setting the network control unit 2 and the network information transferring unit 21 of an address in a header part of a packet, and according to response of request result, the managing unit interface 25 sets specification of the user terminal 2 and the information requesting unit 12 of an address in a header part of a response packet to send the packet to the terminal interface 17 through network 3, and then the interface 17 transfers received information to the priority class selecting unit 13.

The priority class selecting unit 13 determines that it selects which priority according to use conditions of network 3 transferred from the information requesting unit 12 and the policy database (selection policy) 14 that user has.

The utilization requesting unit 15 inputs the selection result of the priority class selecting unit 13 and transmits request of priority class to the network control unit 2 and, as this response, receives usable Id value (referring to Id value hereafter) to transfer information in network from the network control unit 2. The transmitting and receiving unit 16 embeds Id that the utilization requesting unit 15 received into a transmission resource region of a header part of a packet form and conducts transmission and reception of information to network 3.

On the other hand, in the network control unit 2, the network information transferring unit 21 receives reference request of network information from the user terminal 1 and transmits network information to the user terminal 1. The network database 22 stores use information. The request accepting unit 23 receives use request from the user terminal 1, judges whether network 3 is usable and delivers permission ID to the user terminal 1 while updating the network database 22 when acceptance is conducted.

And one example of network information that the network control unit 2 provides to the user terminal 1 is shown in FIG. 2 and FIG. 3, for example, each of priority A class, priority B class and priority C class which are divided into three ranks corresponds to minimum guarantee bandwidth and usable bandwidth.

Furthermore, one example of database information that the network control unit 2 has is shown in FIG. 4 and FIG. 5, for example, each of priority A class, priority B class and priority C class which are divided into three ranks corresponds to all bandwidth, minimum guarantee bandwidth, usable bandwidth and maximum user number. In this case, FIG. 5 shows updated database information in FIG. 4.

The operation of the embodiment of the present invention is described in detail with reference to FIG. 2 to FIG. 7. Since this embodiment is basically similar to the embodiment as shown in FIG. 1, overlapping description will be omitted.

In the user terminal 1, when condition that information is transmitted and received with another terminal, such as the user terminal 4, is occurred, trigger is generated from the transmitting data generating unit 18, and the connection opening trigger detecting unit 11 detects this generation. The connection opening trigger detecting unit 11 informs information that the unit 11 detected this connection opening trigger to the information requesting unit 12 (Step 41 in FIG. 6). Additional information to judge quality of information to be transmitted such as transmission application, amount of transfer information and the like is added to this trigger detection information.

The information requesting unit 12 of the user terminal 1 informs a packet in which an address is as the network information transferring unit 21 of the network control unit 2 to the terminal interface 17 according to this trigger, and the interface 17 transmits this packet to network 3. The managing unit interface 25 of the network control unit 2 detects the packet whose address is the unit 2 from packets sent to network 3 and inputs detected packet to transmit it to the network information transferring unit 21 and conducts request of notice of use conditions of each priority class in network 3 (Step 42 in FIG. 6).

The network information transferring unit 21 refers to the network database 22 according to the foregoing request and transfers this information to the information requesting unit 12, which is a request resource, of the user terminal 1 via network 3 (Step 401 in FIG. 6).

Here, FIG. 2 shows network information which is given at this time, like the embodiment as shown in FIG. 1.

The information requesting unit 12, which received foregoing network information, of the user terminal 1 transfers network information to the priority class selecting unit 13. The priority class selecting unit 13 selects that which priority class is used for information transfer with reference to the policy database 14. The policy database 14 sets, for example, time emergency, lower limit and upper limit of network use amount for information and the like by amount of transfer information, a kind of sending application and the like to maintain policy for selecting suitable priority class.

Since this policy is different by the user terminal, for example, priority is best, low cost is best or data quality is best, it is ranked so that priority is medium, low cost is best and data quality is best, for example, according to user's preference to store them in the policy database 14. The priority class selecting unit 13 determines class selection according to use information of network at present based on this policy (Step 43,44 in FIG. 6).

Next, the priority class selecting unit 13 notifies the utilization requesting unit 15 of the selected priority class (Step 45 in FIG. 6). The utilization requesting unit 15 of the user terminal 1 constructs a packet including information of priority class bandwidth and transmits utilization request to the request accepting unit 23 of the network control unit 2 through the terminal interface 17 and managing unit interface 25.

In this embodiment, it is assumed that request that priority B class is used is conducted based on the policy database 14. At this time, information concerning the user terminal 4 which is an opposed station of communication is also delivered. The utilization requesting unit 15 of the user terminal 1 transfers this information, that is, information that priority B class is used to the request accepting unit 23 of the network control unit 2.

It is assumed that the request accepting unit 23 obtains information shown in FIG. 4 with reference to the network database 22 (Step 402 in FIG. 6). Information of FIG. 4 show that all bandwidth and information of user number are added to information of FIG. 2. Priority B class do not reach maximum user number, it is still possible for service for 40 user until it is specified, therefore, at this time, request is accepted as it is, the fact, noticed from the request accepting unit 23, that the user terminal 1 uses network 3 at priority B class is stored in the network database 22 through the referring and updating unit 24, and the contents which have been not used till now is updated (Step 403,404 in FIG. 6).

When acceptance is impossible, acceptance impossible is judged (Step 405 in FIG. 6). FIG. 5 shows updated database. After this, user who conducted request of information transfer receives information shown in FIG. 3.

The request accepting unit 23 of the network control unit 2 assigns ID so that user can use priority B class in network 3 and informs this to the utilization requesting unit 15 of the user terminal 1. The request accepting unit 23 of the network control unit 2 assigns same ID and informs it to the requesting unit in the user terminal 4 of the opposed station simultaneously. And the request accepting unit 23 of the network control unit 2 conducts operation for opening connection of accepted service for network 3.

The utilization requesting unit 15 of the user terminal 1 delivers this ID to the transmitting and receiving unit 16 and executes transmission and reception of data between itself and opposed user terminal 4 through the terminal interface 17 (Step 406 in FIG. 6).

In addition, in the embodiment described above, an example of the system that user directly specifies priority class in same priority class, however, the system that user only specifies minimum guarantee bandwidth, and the request accepting unit 23 of the network control unit 2 refers to the network database 22 to select suitable class may be applicable. Furthermore, since if a data transmitting resource determined class selection such as priority, there is a case that an opposed user terminal requests priority class of higher rank by one rank, therefore negotiation function may be provided in the network control unit 2.

As described above, in the priority class selection type communication method of the embodiment of the present invention, the specific bandwidth of the transmission channel in the network is classified and divided by priority, and maximum user number is set. In this embodiment, since service is given in network 3 of the network control unit by only connecting with network, it is effective when network system is extended.

Network user can obtain use information of each priority class from network by request of user oneself. It is possible to request and reserve that which priority class is used at how much bandwidth for network by user's policy. User is accounted use charge by the product of used priority class, bandwidth and time. Network contains to maximum user number that each priority class has.

Accordingly, the used bandwidth may gradually decrease due to an increase in users, even when the users are using the bandwidth which exceed minimum guarantee bandwidth.

What is claimed is:

1. A communication system based on priority class selection, which comprises:
a user terminal which requests network information concerning the priority classes, when starting transmission and reception with other user terminal; selects one of said priority classes, on the basis of said network information; requests to use the selected priority class; and communicates with said other user terminal by using a permission ID; and
a network control unit which transmits said network information toward said user terminal on the basis of the request from said user terminal; and transmits said permission ID to said user terminal on the basis of the request to use said selected priority class.

2. The communication system according to claim 1, wherein said user terminal comprises:
a trigger detecting unit for detecting a start trigger signal of transmission and reception of information between itself and another user terminal;
an information requesting unit for conducting request of network information of said priority classes to said network control unit;
a policy database for storing data for selecting one of said priority classes;
a selecting unit for selecting one of said priority classes on the basis of said network information and said policy data base;
a utilization requesting unit for requesting to use the selected priority class to said network control unit; and
transceiver unit for transmits and receives information through said network by using said permission ID received from said network control unit on the basis of the utilization request,
and wherein said network control unit comprises:
transferring unit for receiving the request of the network information from the user terminal and transmit the network information to the user terminal;
a network database for storing and updating said network information; and
an accepting unit for accepting said utilization request from said user terminal and transmitting said permission ID to said user terminal.

3. The communication system according to claim 1, wherein:
each of said priority classes has specific account system; and
a unit price per unit bandwidth becomes high, as said maximum users become small.

4. The communication system according to claim 1, wherein each of said priority classes is classified in terms of a whole bandwidth, a minimum guarantee bandwidth, a usable bandwidth and maximum users.

5. A communication method based on priority class selection, which comprises the steps of:
dividing a specific bandwidth into a plurality of priority classes; and
setting up maximum users for each of said priority classes,
wherein a minimum bandwidth prescribed for each of said priority classes is guaranteed, even when said maximum users select said priority class.

6. The communication method according to claim 5, which further comprises the steps of:
requesting from a user terminal network information of said priority classes, when starting transmission and reception of information between user terminals;
selecting by said user terminal one of said priority classes on the basis of said network information received from a network control unit;
requesting from said user terminal to utilize the selected priority class to said network control unit; and
communicating between said user by using permission ID received from said network control unit.

7. The communication method according to claim 5, wherein:
each of said priority classes has specific account system; and
a unit price per unit bandwidth become high, as said maximum users become small.

8. The communication method according to claim 5, wherein each of said priority classes is classified in terms of a whole bandwidth, a minimum guarantee bandwidth, a usable bandwidth and maximum users.
